(19) United States
(12) Patent Application Publication
(10) Pub. No.: US 2023/0304634 A1
(43) Pub. Date: Sep. 28, 2023

(54) EZAir Systems

(71) Applicant: Kimberly Ann Cleman, Beecher, IL (US)

(72) Inventors: Shaun F. Leschkies, Beecher, IL (US); Kimberly A. Coleman, Beecher, IL (US)

(73) Assignees: Shaun F. Leschkies, Beecher, IL (US); Kimberly A. Cleman, Beecher, IL (US)

(21) Appl. No.: 17/704,785

(22) Filed: Mar. 25, 2022

(51) Int. Cl. F17C 7/00

(52) U.S. Cl. CPC F17C 7/00; F17C 2221/031; F17C 2223/035; F17C 2205/0338; F17C 2201/0119; F17C 2270/0545; F17C 2201/058

(57) ABSTRACT

A multiple component system consisting of segments that connect to a high-pressure canister, forming a compact pneumatic delivery system. A typical cylinder capable of storing high pressure air is utilized for construction pneumatic tool operation. By connecting the tool to a two-stage regulator using a custom fitted air hose, normal low-pressure operation of construction pneumatic tools can accomplish. The air regulation system is adjustable for output pressure making it compatible with a wide range of construction pneumatic tools. The entire pneumatic delivery system is compact and offers untethered mobility, fitting all components on the user's belt.

The present invention includes independent segments that connect to forming a complete pneumatic delivery system. A typical cylinder, capable of storing high pressure air, is utilized by connecting a two-stage regulator to a custom fitted air hose. This system can deliver an adjustable low-pressure flow of air, allowing for efficient use of standard pneumatic tools in the construction industry. This system is safe, compact and offers full mobility to the user without the need for long connected hoses or heavy equipment.

EZAir Systems™ configuration gives the user the ability to move around a construction project safely while eliminating the need for long air hoses, power cords or even electricity. Current methods of construction often require heavy, loud and energy depleting equipment to provide for the utilization of pneumatic tools. Air compressors and generators are typically used in most construction settings yet may not always be available or their use practical. Any Pneumatic construction tool using a standard ¼ ″ fitting can be attached to the end of EZAir Systems™ configuration and immediately operated. EZAir Systems™ configuration and high pressure air cylinder are attached to the belt of the user, making accessibility immediate and effortless. Having a compact and efficient design, untethered access to any standard pneumatic tool can be operated from the user's belt.

EZAir Systems™ configuration offers easy charging of re-fillable cylinders, with the use of a high pressure air compressor. High pressure air has been used for decades in many industries, proving to be both safe and highly effective. High pressure air cylinders, using EZAir Systems™ configuration, brings this history of usefulness to the construction industry. Previous attempts at a reliable, compact system failed due to the difficulty of finding a certified CO2 refilling station. Users often had to travel over 30 miles to find a refill center in addition to paying a premium price to refill each cylinder. Users now can recharge cylinders from the comfort of their own home or business without any additional cost.

### BACKGROUND OF THE INVENTION

Having extensive experience in construction, more specifically home building, the use of pneumatic tools was an everyday occurrence. Much time was wasted taking out the equipment necessary in operating the pneumatic tools. There were some jobs where heavy equipment wasn't even allowed in the building, or where power was not available on site for a compressor. Another issue encountered was the constant attaching and detaching of the air hose anytime the location of work changed. The air hose would get wound up in between framing members, making mobility and use very limited. More recently, inclement weather has created the need for emergency repair work. Simple repairs would still require all the same heavy equipment or having to manually fasten building materials.

EZAir Systems™ has been invented and designed to improve aspects of mobility and convenience to the Construction Industry. The system eliminates the need to haul compressors, generators, and fuel tanks to the smallest jobs, as well as the added inconvenience of navigating either a remote or high-density urban setting. By using EZAir Systems™, any pneumatic construction tool can now be operated immediately upon connection with a high pressure air cylinder. This system has direct benefit to any tradesman who uses pneumatic tools and who does not want to be bound to a set location or heavy equipment.

### BRIEF SUMMARY OF THE INVENTION

EZAir Systems™ eliminates the need for construction industry tradesmen to carry and move heavy equipment such as air compressors and power generators when electric is unavailable. This system is safe, powerful, and compact, harnessing the power of high pressure air through a specialized 2-stage regulator and hose configuration to deliver air in the controlled pound per square inch required to run any pneumatic tool effectively and efficiently. Instead of using carts or dollies to move heavy equipment around a jobsite, EZAir Systems™ attaches and operates pneumatic tools from a belt.

### BRIEF DESCRIPTION OF THE SEVERAL VIEWS OF THE DRAWING

FIG. 1 is an exploded perspective view of the invention configuration, illustrating a complete EZAir Systems™ including a high pressure air dually regulated cylinder with attached hose and standard pneumatic tool attachment fitting.

FIG. 2 is a top plan view of the high pressure air cylinder body, revealing the outlet female thread.

FIG. 3 shows side views of the high pressure air fill regulator, illustrating the details of the ports and connections.

FIG. 4A is a perspective view of the air pressure output regulator of the invention configuration, in its fully assembled form.

FIG. 4B is a perspective view of the upper housing of the air pressure output regulator illustrating the details of the ports and connections.

FIG. 4C shows top plan, and multiple side views of the lower housing of the air pressure output regulator illustrating the details of the ports and connections.

FIG. 5 is a perspective view of the air hose configuration illustrating the detail of the connections.

### DETAILED DESCRIPTION OF THE INVENTION

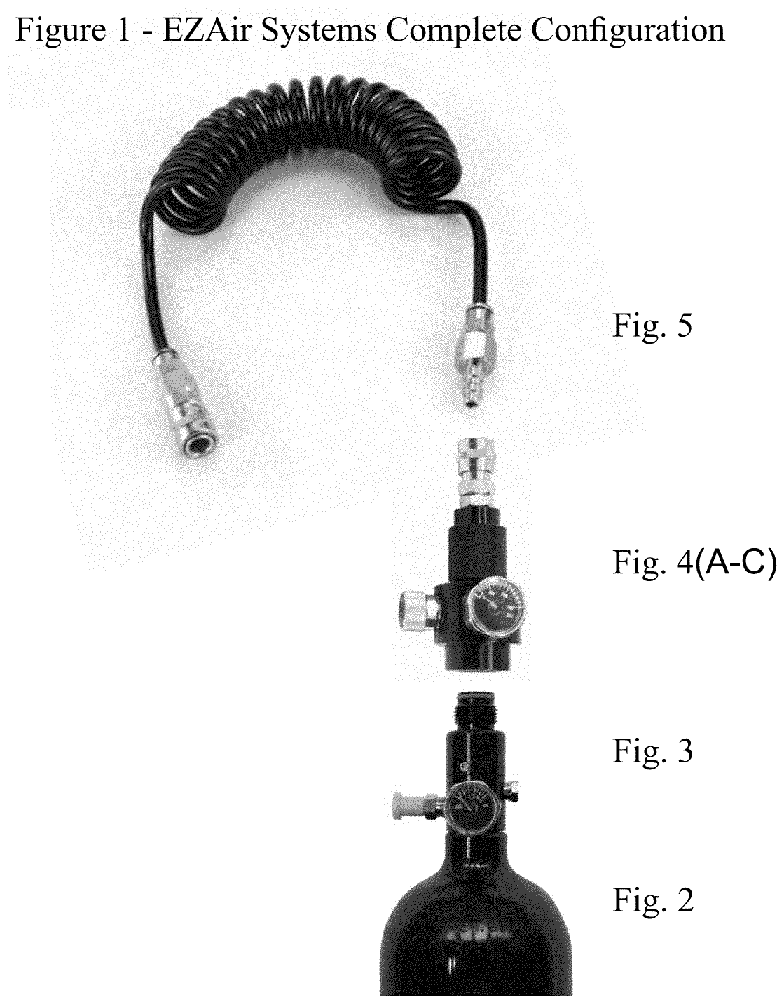

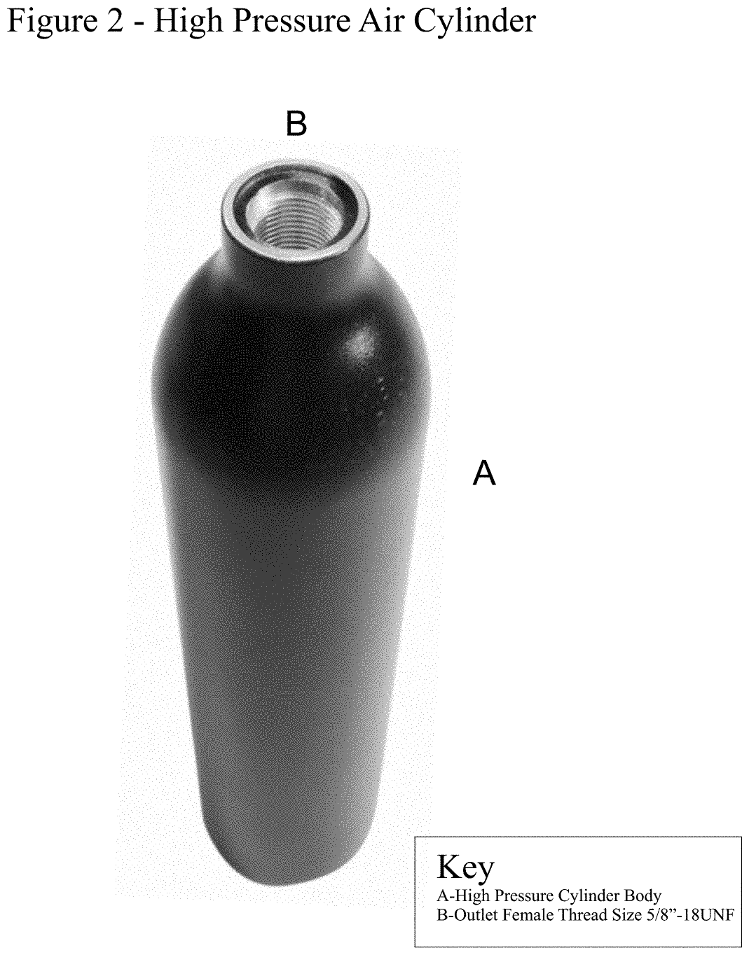

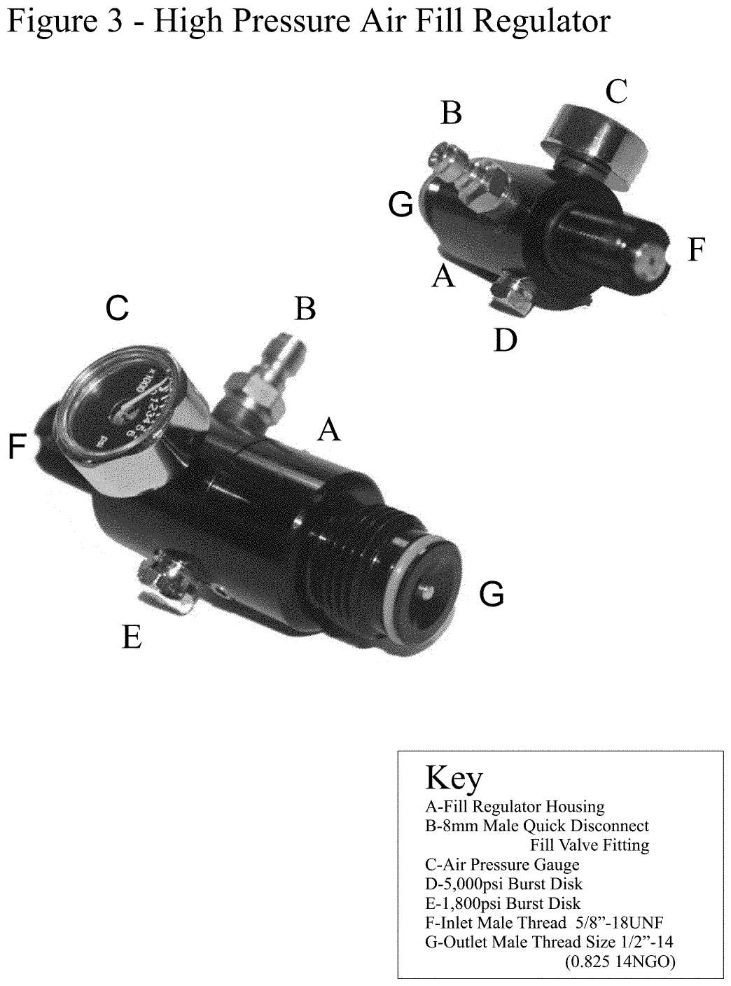

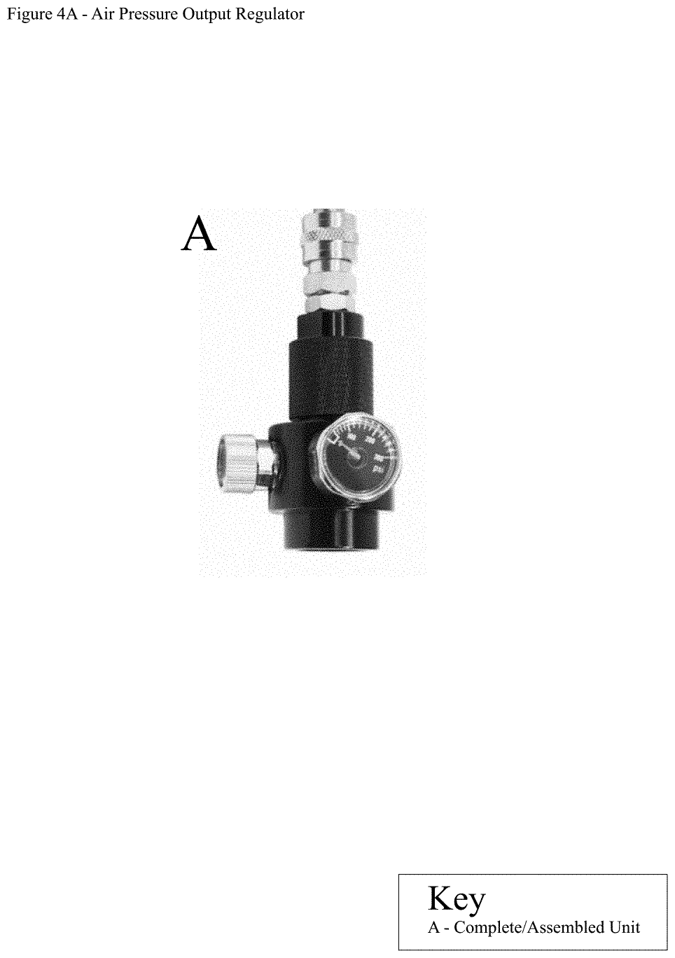

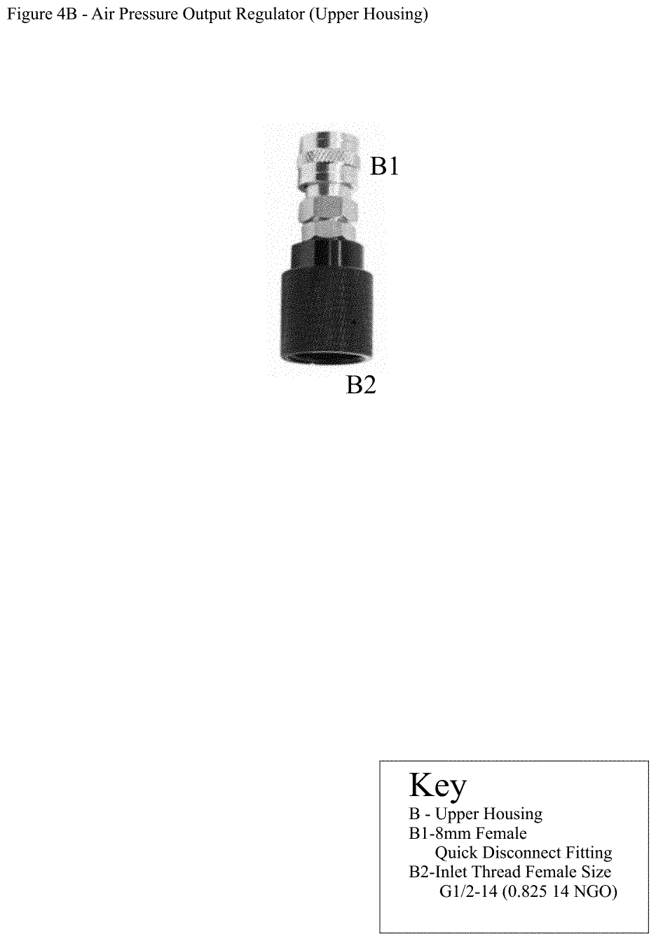

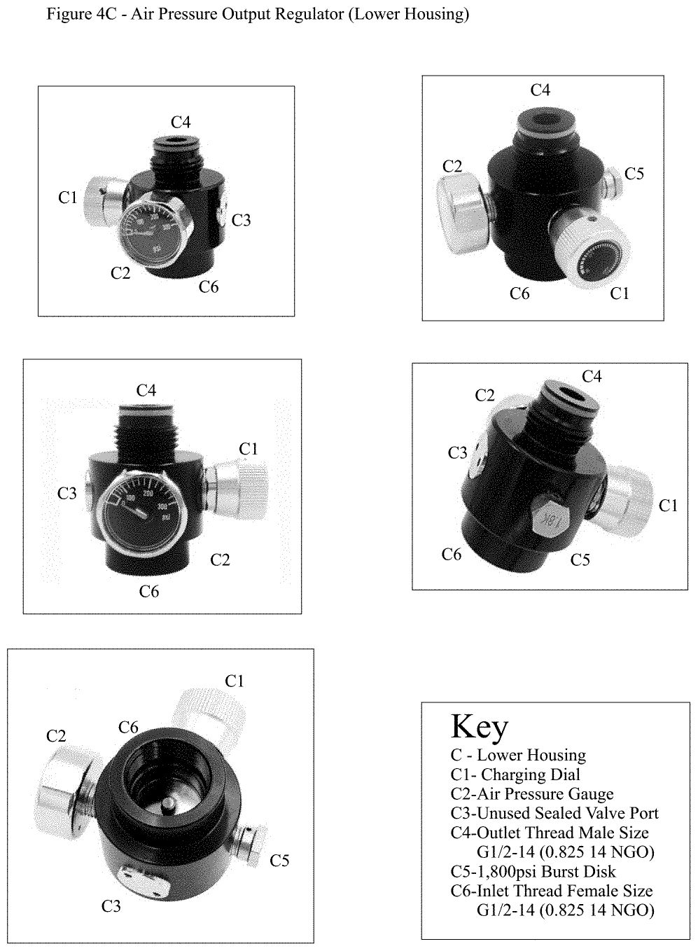

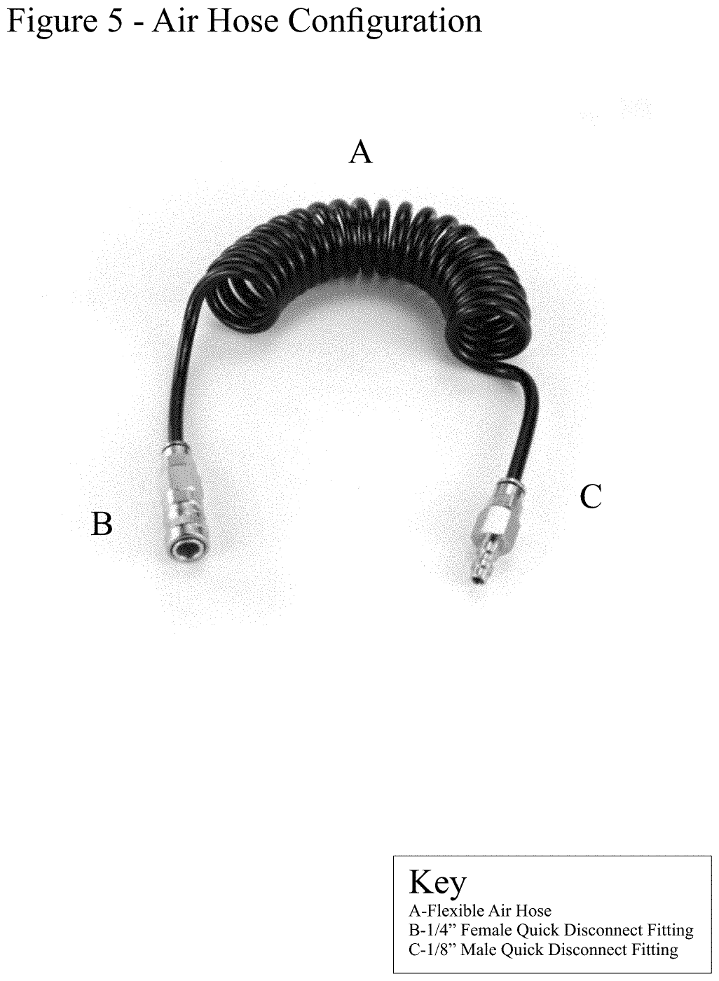

Referring to FIG. 1, illustrated is an EZAir Systems™ complete configuration consisting of all the components involved in the transfer of high pressure air stored in a regulated cylinder (FIGS. 2 and 3) to an additional regulator (FIG. 4) delivering reduced and operable air pressure through a flexible hose and standard pneumatic tool fitting (FIG. 5).

Referring to FIG. 2, the high pressure air cylinder body is shown open and uncapped, revealing the female output thread size of ⅝ inch—18UNF.

Referring to FIG. 3, illustrated is the high pressure air fill regulator revealing the valve connections and gauge required to fill and regulate high pressure air up to 4000 psi within a cylinder body (FIG. 2A). FIG. 3 is made up of the fill regulator housing (FIG. 3A) with attached air pressure gauge (FIG. 3C), burst disks at each level of air regulation (FIGS. 3D and 3E), an 8 mm male quick disconnect fill valve (FIG. 3B), connected to the cylinder by a threaded male inlet (FIG. 3F). The male inlet connection of the fill regulator (FIG. 3F) is attached to the female outlet connection of cylinder body (FIG. 2B) via the thread size of ⅝ inch—18UNF. Upon installation of the fill regulator (FIG. 3) to the cylinder body (FIG. 2A) high pressure air can be safely contained within the system, by charging the cylinder via the 8 mm male quick disconnect fill valve (FIG. 3B).

Referring to FIG. 4, illustrated is the complete air pressure output regulator which includes an upper housing (FIG. 4B) and lower housing (FIG. 4C). The upper and lower housing are fixed together via the inlet female port (FIG. 4 B2) from the upper housing to the outlet male port (FIG. 4 C4) of the lower housing. The upper housing (FIG. 4B) allows for the connection of the air hose configuration (FIG. 5) using the attached female 8 mm quick disconnect fitting (FIG. 4 B1). The charging dial (FIG. 4 C1) located on the lower housing (FIG. 4C), controls the flow of air entering the regulator. Turning the dial clockwise, increases the psi on the air pressure gauge (FIG. 4 C2) up to 200 psi, well above the operable range of all pneumatic construction tools. A burst disk (FIG. 4 C5) is installed on the regulator to offer an element of safety, discharging high pressure air out of the system before tools can be damaged. The lower housing of the output regulator (FIG. 4C) contains an unused sealed valve port (FIG. 4 C3) which is a result of the housing being drilled through on all sides, during the manufacturing process. The air pressure output regulator (FIG. 4A) is fixed to the high pressure air fill regulator (FIG. 3) via the inlet female port (FIG. 4 C6) and male outlet (FIG. 3G), with the threaded size G1/2-14 (0.825 14 NG0).

Referring to FIG. 5, illustrated is the air hose configuration including the flexible, high flow air hose (FIG. 5A) with an 8 mm male quick disconnect fitting (FIG. 5C) on one end and a ¼″ female quick disconnect fitting (FIG. 5B) on the other end. The air hose configuration (FIG. 5) is fitted to the air pressure output regulator (FIG. 4) via the 8 mm male quick disconnect fitting (FIG. 5C). The air hose configuration (FIG. 5) can be attached to any standard ¼″ pneumatic construction tool directly via the ¼″ female quick disconnect fitting (FIG. 5B). The EZAir Systems™ complete configuration (FIG. 1) has been illustrated and described. While a particular form of the invention configuration has been illustrated and described, it will be apparent that various modifications can be made without departing from the spirit and scope of the invention. Accordingly, it is not intended that the invention configuration be limited, except as by the appended claims.

1. EZAir Systems™ configuration gives the user the ability to move around a construction project safely while eliminating the need for long air hoses, power cords or even electricity.

2. EZAir Systems™ configuration offers easy charging of re-fillable cylinders, with the use of a high pressure air compressor.
